(19) United States
(12) Patent Application Publication
(10) Pub. No.: US 2014/0048677 A1
(43) Pub. Date: Feb. 20, 2014

(54) BEARING CUP BASE AND FAN FRAME ASSEMBLY USING SAME

(71) Applicant: Chiu-Mao Huang, New Taipei City (TW)

(72) Inventor: Chiu-Mao Huang, New Taipei City (TW)

(21) Appl. No.: 13/589,541

(22) Filed: Aug. 20, 2012

(51) Int. Cl. F16C 35/02; F16M 1/04

(52) U.S. Cl. 248/637; 384/428

(57) ABSTRACT

A bearing cup base and a fan frame assembly provided with same are disclosed. The bearing cup base includes a base body having a first side, a bearing cup perpendicularly forward extended from the first side of the base body, and a printed circuit layer formed on the first side. By directly forming the printed circuit layer on the bearing cup base, a fan using the bearing cup base can be manufactured at largely reduced cost and can have a further reduced overall height.

### FIELD OF THE INVENTION

The present invention relates to a bearing cup base, and more particularly to a bearing cup base having a printed circuit layer directly formed thereon. The present invention also relates to a fan frame assembly using the above bearing cup base with a printed circuit layer formed thereon, so as to save the manufacturing cost and reduce an overall height of a fan.

### BACKGROUND OF THE INVENTION

A fan is a requisite heat dissipation element in an electronic device, and is mainly used to force heat away from a heat source or from a heat sink. Generally, different types of fans, such as cross flow fan, axial flow fan and centrifugal fan, are provided according to actual needs in different working environments. Further, to control the rotational speed of a fan, a control circuit is usually provided on a circuit board in the fan; and the circuit board is usually arranged below a stator assembly of the fan or on a bottom of a fan frame.

In response to the miniaturization of various electronic apparatus and electronic devices, the fans for them must also be reduced in size. For mounting in a limited space, the small-size fan must be low in profile. That is, all necessary elements in the fan, such as the rotor assembly and the stator assembly, must also have reduced height or thickness. Even the circuit board, either a rigid or a flexible one, forms a factor having influence on the height of a thin fan. However, in the past, in view that the control circuit is requisite for controlling the fan rotational speed, the circuit board is normally maintained as an important item in the fan and accounts for a considerably large part of the fan manufacturing cost.

### SUMMARY OF THE INVENTION

A primary object of the present invention is to provide a bearing cup base that enables a fan using same to have reduced manufacturing cost and further reduced overall thickness.

Another object of the present invention is to provide a fan frame assembly that enables a fan using same to have reduced manufacturing cost and further reduced overall thickness.

To achieve the above and other objects, the bearing cup base according to the present invention includes a base body having a first side, a bearing cup perpendicularly forward extended from the first side of the base body, and a printed circuit layer formed on the first side.

To achieve the above and other objects, the fan frame assembly according to an embodiment of the present invention includes a bearing cup base and a frame body.

The bearing cup base includes a base body having a first side, a bearing cup perpendicularly forward extended from the first side of the base body, and a printed circuit layer formed on the first side.

The frame body includes a bottom portion defining a first end opening and an extension portion perpendicularly located on and connected to a peripheral edge of the bottom portion. The bearing cup base is centered in the first end opening and connected to the frame body via a plurality of connecting members.

To achieve the above and other objects, the fan frame assembly according to another embodiment of the present invention includes a frame body having a bottom portion and an extension portion perpendicularly connected to the bottom portion. The extension portion has an opening formed thereon. The bottom portion has a bearing cup provided thereon and a seat located around the bearing cup. The seat has a printed circuit layer provided thereon and is connected to the bottom portion via a plurality of connecting members, so that the seat and the connecting members together define a plurality of holes on the bottom portion.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 is a perspective view of a first embodiment of a bearing cup base according to the present invention;

FIG. 2 is a perspective view of a second embodiment of the bearing cup base according to the present invention;

FIG. 3 is an exploded perspective view of a third embodiment of the bearing cup base according to the present invention;

FIG. 4 is a perspective view of a first embodiment of a fan frame assembly according to the present invention;

FIG. 5 is a perspective view of a second embodiment of the fan frame assembly according to the present invention; and

FIG. 6 is a perspective view of a third embodiment of the fan frame assembly according to the present invention.

### DETAILED DESCRIPTION OF THE PREFERRED EMBODIMENTS

The present invention will now be described with some preferred embodiments thereof and with reference to the accompanying drawings. For the purpose of easy to understand, elements that are the same in the preferred embodiments are denoted by the same reference numerals.

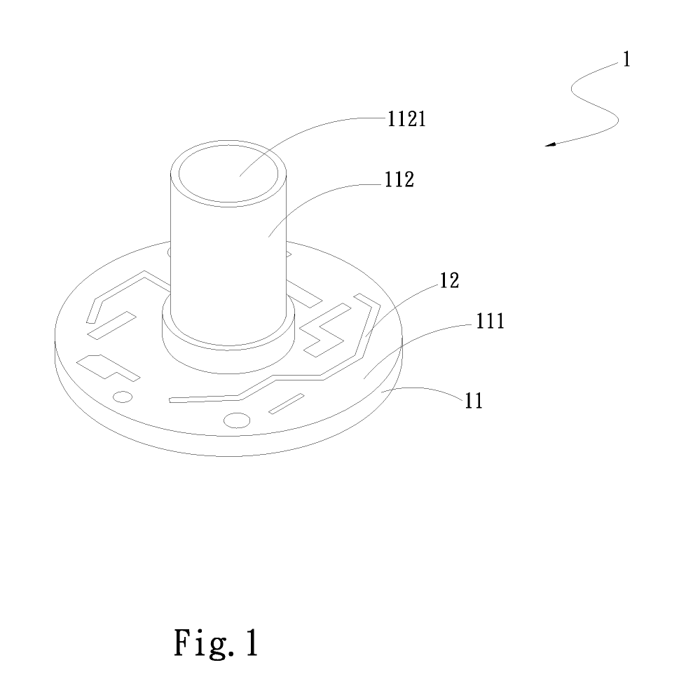

Please refer to FIG. 1 that is a perspective view of a first embodiment of a bearing cup base 1 according to the present invention. As shown, the bearing cup base 1 includes a base body 11. The base body 11 has a first side 111 and a bearing cup 112 extended in a direction perpendicular to and away from the first side 111. The bearing cup 112 internally defines a receiving space 1121 for arranging bearings therein. The first side 111 of the base body 11 has a printed circuit layer 12 formed thereon by way of mechanical processing, such as printing, laser sculpturing or other suitable manners. The printed circuit layer 12 is located on the first side 111 in the vicinity of the bearing cup 112.

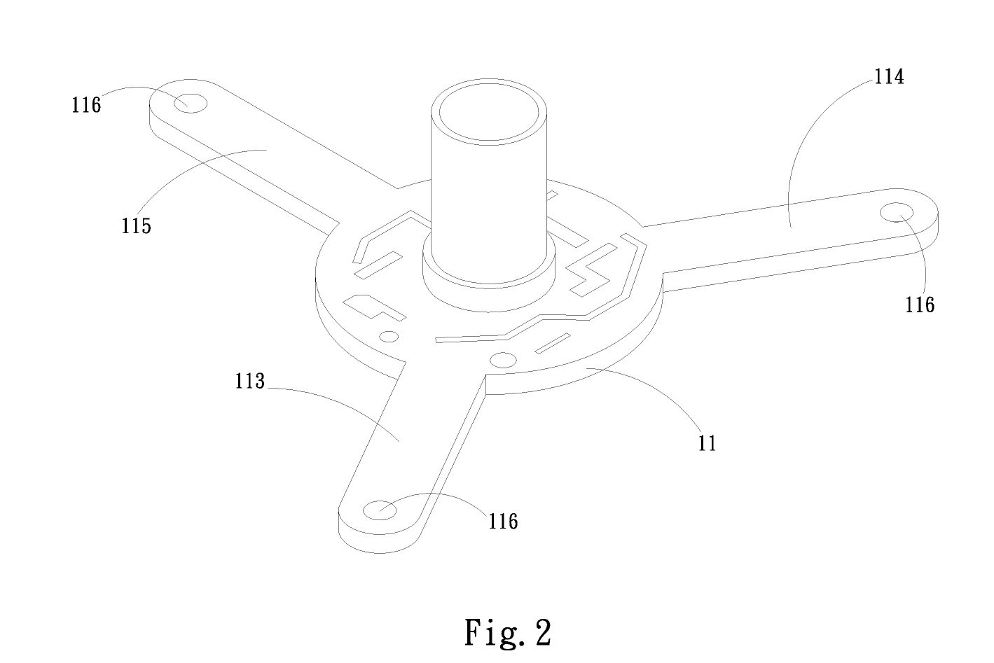

FIG. 2 is a perspective view of a second embodiment of the bearing cup base according to the present invention. As shown, the bearing cup base in the second embodiment is generally structurally similar to the first embodiment, except that the base body 11 in the second embodiment further includes a first extension arm 113, a second extension arm 114, and a third extension arm 115. The first, second and third extension arms 113, 114, 115 are extended from an outer peripheral edge of the base body 11 in directions away from the base body 11, and provided on respective distal end with a mounting hole 116.

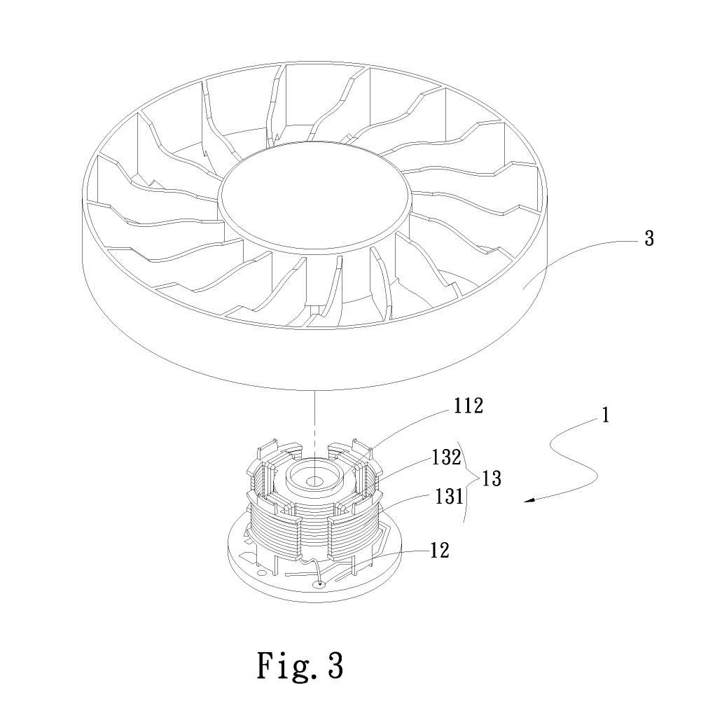

FIG. 3 is an exploded perspective view of a third embodiment of the bearing cup base 1 according to the present invention. As shown, the bearing cup base 1 in the third embodiment is generally structurally similar to the first embodiment, except that the bearing cup 112 in the third embodiment has a stator assembly 13 externally fitted therearound. The stator assembly 13 includes a plurality of silicon steel plates 131 wound around by coils 132. The coils 132 are electrically connected to the printed circuit layer 12.

The bearing cup base 1 in the third embodiment can be assembled to a corresponding fan element, which is illustrated in FIG. 3 as a blade assembly 3 of a ring-type fan but is not necessarily limited thereto.

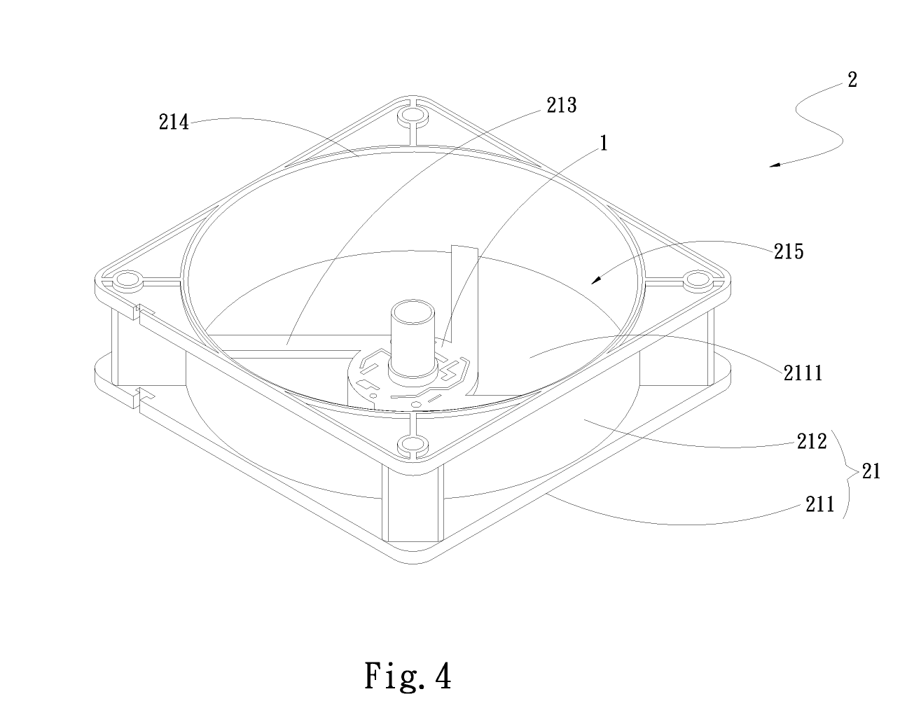

Please refer to FIG. 4 that is a perspective view of a first embodiment of a fan frame assembly 2 according to the present invention. As shown, the fan frame assembly 2 includes a bearing cup base 1 and a frame body 21.

The bearing cup base 1 has a structure the same as that of the first embodiment of the bearing cup base according to the present invention and is therefore not repeatedly described herein. The frame body 21 includes a bottom portion 211 defining a first end opening 2111 and an extension portion 212 perpendicularly upward extended from the bottom portion 211. The bearing cup base 1 is centered in the first end opening 2111 and is connected to the frame body 21 via a plurality of connecting members 213. The connecting members 213 can be ribs or flow-guiding impellers. In the first embodiment of the fan frame assembly 2, the connecting members 213 are illustrated as ribs but not necessarily limited thereto.

The frame body 21 further includes an open portion 214 located at one side of the frame body 21 opposite to the bottom portion 211. And, a passage 215 is formed between the open portion 214 and the bottom portion 211.

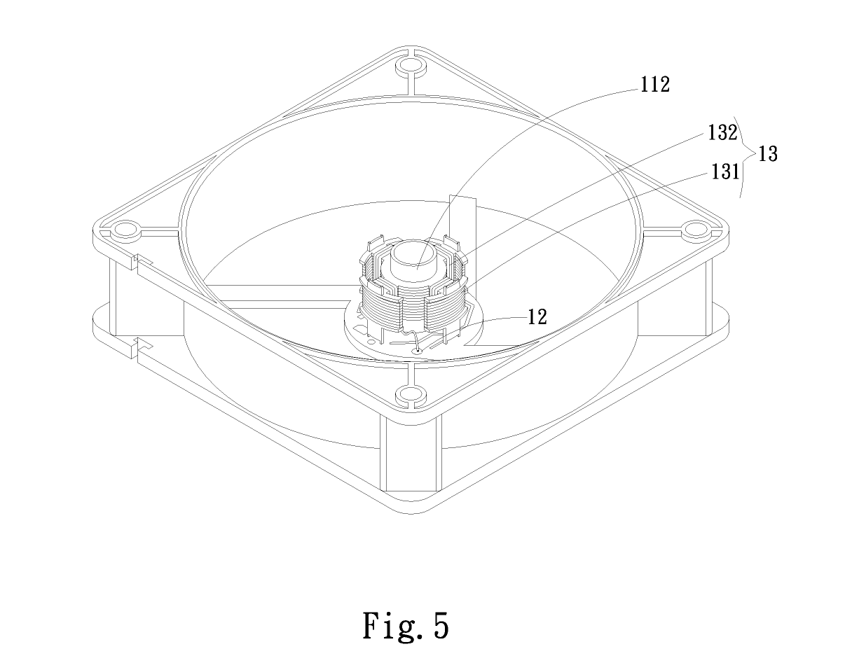

FIG. 5 is a perspective view of a second embodiment of the fan frame assembly according to the present invention. As shown, the fan frame assembly in the second embodiment is structurally similar to the first embodiment, except that the bearing cup 112 of the bearing cup base has a stator assembly 13 externally fitted therearound. The stator assembly 13 includes a plurality of silicon steel plates 131 wound around by coils 132. The coils 132 are electrically connected to the printed circuit layer 12.

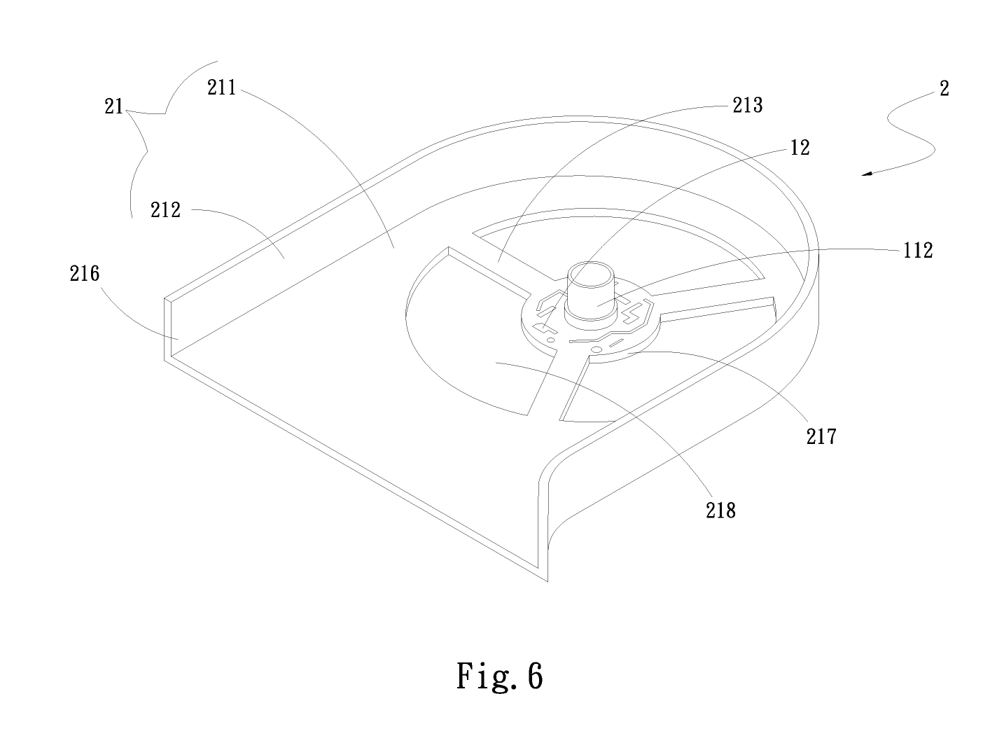

FIG. 6 is a perspective view of a third embodiment of the fan frame assembly according to the present invention. As shown, the fan frame assembly 2 includes a frame body 21 having a bottom portion 211 and an extension portion 212 perpendicularly connected to the bottom portion 211. The extension portion 212 has an opening 216 formed thereon. The bottom portion 211 has a bearing cup 112 provided thereon and a seat 217 located around the bearing cup 112. The seat 217 has a printed circuit layer 12 formed thereon and is connected to the bottom portion 211 via a plurality of connecting members 213, so that the seat 217 and the connecting members 213 together define a plurality of holes 218 on the bottom portion 211.

Since the bearing cup bases 1 in the first, second and third embodiments of the fan frame assembly 2 respectively have a structure corresponding to that of the first, second and third embodiments of the bearing cup base 1 according to the present invention, they are not repeatedly described in details herein.

As illustrated in the above embodiments of the present invention, since the printed circuit layer 12 is directly formed on the bearing cup base 1 or on the fan frame assembly 2, it is able to save the cost and the mounting space for an individual circuit board. As a result, it is possible to further largely reduce an overall height or thickness of a fan.

The present invention has been described with some preferred embodiments thereof and it is understood that many changes and modifications in the described embodiments can be carried out without departing from the scope and the spirit of the invention that is intended to be limited only by the appended claims.

What is claimed is:

1. A bearing cup base, comprising a base body having a first side, a bearing cup perpendicularly forward extended from the first side of the base body, and a printed circuit layer formed on the first side of the base body.

2. The bearing cup base as claimed in claim 1, wherein the base body further includes a first extension arm, a second extension arm, and a third extension arm; the first, second and third extensions arms extending from a peripheral edge of the base body in directions away from the base body, and being provided on respective distal end with a mounting hole.

3. The bearing cup base as claimed in claim 1, wherein the bearing cup has a stator assembly externally fitted therearound; the stator assembly including a plurality of silicon steel plates wound around by a plurality of coils, and the coils being electrically connected to the printed circuit layer.

4. The bearing cup base as claimed in claim 1, wherein the printed circuit layer is located on the first side of the base body in the vicinity of the bearing cup.

5. A fan frame assembly, comprising:
a bearing cup base including a base body having a first side, a bearing cup perpendicularly forward extended from the first side of the base body, and a printed circuit layer formed on the first side of the base body; and
a frame body including a bottom portion defining a first end opening and an extension portion perpendicularly upward extended from the bottom portion;
wherein the bearing cup base is centered in the first end opening and is connected to the frame body via a plurality of connecting members.

6. The fan frame assembly as claimed in claim 5, wherein the frame body further includes an open portion located at one side of the frame body opposite to the bottom portion, so that a passage is formed between the open portion and the bottom portion.

7. The fan frame assembly as claimed in claim 5, wherein the connecting members are selected from the group consisting of ribs and flow-guiding impellers.

8. The fan frame assembly as claimed in claim 5, wherein the bearing cup has a stator assembly externally fitted therearound; the stator assembly including a plurality of silicon steel plates wound around by a plurality of coils, and the coils being electrically connected to the printed circuit layer.

9. The fan frame assembly as claimed in claim 5, wherein the printed circuit layer is located on the first side of the base body in the vicinity of the bearing cup.

10. A fan frame assembly, comprising a frame body; the frame body including a bottom portion and an extension portion perpendicularly connected to the bottom portion and having an opening formed thereon; the bottom portion having a bearing cup provided thereon and a seat located around the bearing cup; the seat having a printed circuit layer formed thereon and being connected to the bottom portion via a plurality of connecting members, so that the seat and the connecting members together define a plurality of holes on the bottom portion.
